(19) United States
(12) Patent Application Publication
(10) Pub. No.: US 2015/0158371 A1
(43) Pub. Date: Jun. 11, 2015

(54) AUTOMATIC MOUNTING DEVICE OF DOOR HINGE FOR VEHICLE

(71) Applicants: Kia Motors Corporation, Seoul (KR); Hyundai Motor Company, Seoul (KR)

(72) Inventor: Tae Heun JIN, Gyeongsan-si (KR)

(73) Assignees: Kia Motors Corporation, Seoul (KR); Hyundai Motor Company, Seoul (KR)

(21) Appl. No.: 14/201,419

(22) Filed: Mar. 7, 2014

(30) Foreign Application Priority Data
Dec. 6, 2013 (KR) 10-2013-0151374

(51) Int. Cl. B60J 5/04; E05D 11/00; B25J 9/16

(52) U.S. Cl. CPC B60J 5/0468; B25J 9/1687; B25J 9/1694; E05D 11/00; Y10S 901/41; Y10S 901/31

(57) ABSTRACT

An automatic mounting device of a door hinge for a vehicle, may include a door hinge mounting unit configured to automatically mount a door hinge to a side panel of the vehicle, and a robot hanger unit mounted on the door hinge mounting unit, coupled to an automatic robot, and configured to allow the door hinge mounting unit to move.

### CROSS-REFERENCE TO RELATED APPLICATION

The present application claims priority to Korean Patent Application No. 10-2013-0151374, filed on Dec. 6, 2013, the entire contents of which is incorporated herein for all purposes by this reference.

### BACKGROUND OF THE INVENTION

1. Field of the invention

The present invention relates to an automatic mounting device of a door hinge for a vehicle, and more particularly, to an automatic mounting device of a door hinge for a vehicle which improves work efficiency and reduces cost by using a nut runner in common when automatically mounting door hinges for a front door and a rear door to an side panel of a vehicle.

2. Description of Related Art

Vehicle doors are typically located on side panels of a vehicle body and are opened and closed through door hinges.

Process to marry vehicle doors with a vehicle body in factories for manufacturing vehicle bodies includes mounting door hinges on front and rear pillars of side panels of a vehicle and fastening doors to the door hinges.

Further, in the process of mounting door hinges, when a vehicle body is carried to a work place by a conveyer system, door hinges are bolted to upper and lower door hinge mounts on front and rear pillars while being in close contact therewith by using a door hinge mounting jig.

The door hinge mounting jig basically has a structure that may bring the door hinges in close contact with the upper and lower door hinge mounts of the front and rear pillars when it is matched with side panels of a vehicle.

However, there are shortcomings in the related art in that door hinges may be erroneously mounted since the door hinges are manually bolted, such that work efficiency decreases and work time increases due to repeated mounting of door hinges.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an automatic mounting device of a door hinge for a vehicle which improves work efficiency and reduces the cost by using a nut runner in common when automatically mounting door hinges for a front door and a rear door to a side panel of a vehicle.

In an aspect of the present invention, an automatic mounting device of a door hinge for a vehicle, may include a door hinge mounting unit configured to automatically mount a door hinge to a side panel of the vehicle, and a robot hanger unit mounted on the door hinge mounting unit, coupled to an automatic robot, and configured to allow the door hinge mounting unit to move.

The door hinge mounting unit may include the door hinge fixing member configured to restrict a movement of the door hinge when the door hinge is mounted on the side panel of the vehicle, a first clamp configured to fix positions of the side panel of the vehicle and the door hinge mounting unit, and a tooling pin configured to provide a reference for mounting the door hinge.

The door hinge mounting unit may have a plurality of sockets formed therein for fastening bolts, and the robot hanger unit may have nut runners being inserted into the sockets and mounting the door hinge to the side panel of the vehicle by fastening the bolts.

The robot hanger unit may include a location pin configured to connect the robot hanger unit with the door hinge mounting unit, and a second clamp configured to fix the door hinge mounting unit.

A holder configured to pick up the door hinge is disposed at a front of the door hinge mounting unit.

A fixing member configured to fix the side panel of the vehicle and the door hinge mounting unit when the door hinge is mounted is disposed at a front of the door hinge mounting unit.

The fixing member is rotatable and selectively fixes between the side panel and the door hinge mounting unit.

The door hinge mounting unit is detachable from the robot hanger unit.

A plurality of insertion holes is formed in the door hinge mounting unit, and a plurality of floating pins is formed on the robot hanger unit and inserted in the insertion holes.

A sensor configured to sense a tooling hole in the side panel of the vehicle where the door hinge is mounted is disposed at a front of the door hinge mounting unit.

A plurality of door hinge mounting unit is provided and mounted on the robot hanger unit, depending on types of vehicles.

The automatic robot is coupled to the door hinge mounting unit through the robot hanger unit and a control unit is disposed in the door hinge mounting unit so that the door hinge is mounted on the side panel of the vehicle by the door hinge mounting unit.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing a door hinge mounting unit and a robot hanger unit before they are combined, in an automatic mounting device of a door hinge for a vehicle of the present invention.

FIG. 2 is a view showing the combined door hinge mounting unit and the robot hanger unit, in the automatic mounting device of a door hinge for a vehicle of the present invention.

FIG. 3A is a view showing main parts of the automatic mounting device of a door hinge for a vehicle of the present invention.

FIG. 3B is a view showing main parts of the automatic mounting device of a door hinge for a vehicle of the present invention.

FIG. 4 is a view showing the automatic mounting device of a door hinge for a vehicle of the present invention.

FIG. 5 is a view showing the rear side of the automatic mounting device of a door hinge for a vehicle of the present invention.

FIG. 6 is a view showing the front side of the automatic mounting device of a door hinge for a vehicle of the present invention.

FIG. 7 is a view showing an example of the automatic mounting device of a door hinge for a vehicle of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Embodiments of the present invention will be described hereafter in detail with reference to the accompanying drawings.

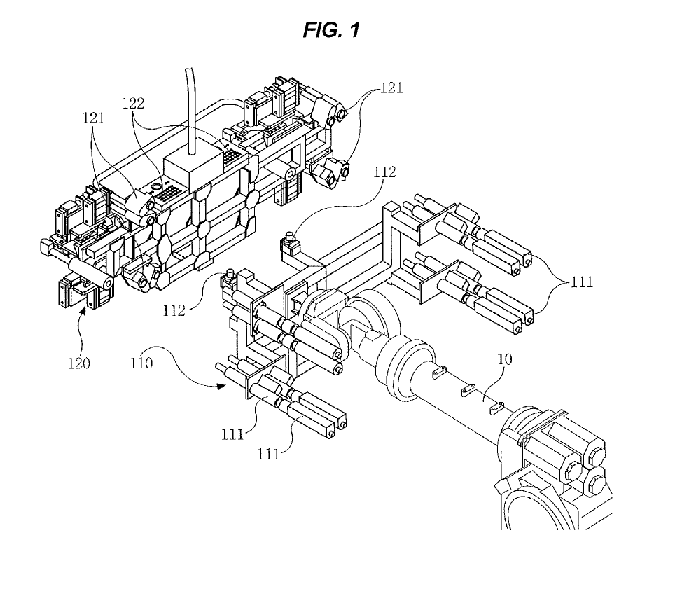

An automatic mounting device of a door hinge for a vehicle of the present invention, as shown in FIGS. 1 to 7, includes a door hinge mounting unit 120 that mounts door hinges to a side panel of a vehicle and a robot hanger unit 110 that is mounted on a the door hinge mounting unit 120 and connected with an automatic robot.

Although the automatic mounting device 100 of a door hinge for a vehicle of the present invention is basically used for systems that mount door hinges to vehicle bodies, it may be used in various fields relating to processes of tightening nuts in addition to door hinges.

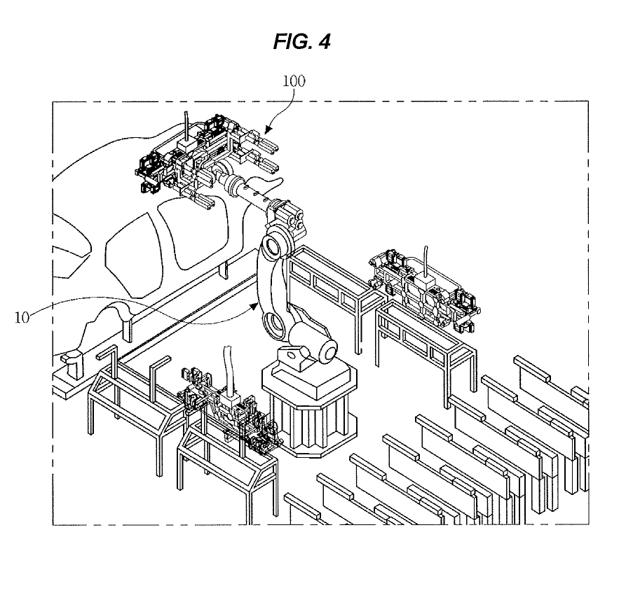

The automatic mounting device 100 of a door hinge of the present invention, a piece of equipment for automatically mounting door hinges to a side panel of a vehicle, includes, as shown in FIG. 4, an automatic robot 10 that rotates and moves the door hinge mounting unit 120 picking up and fastening door hinges to a side panel of a vehicle.

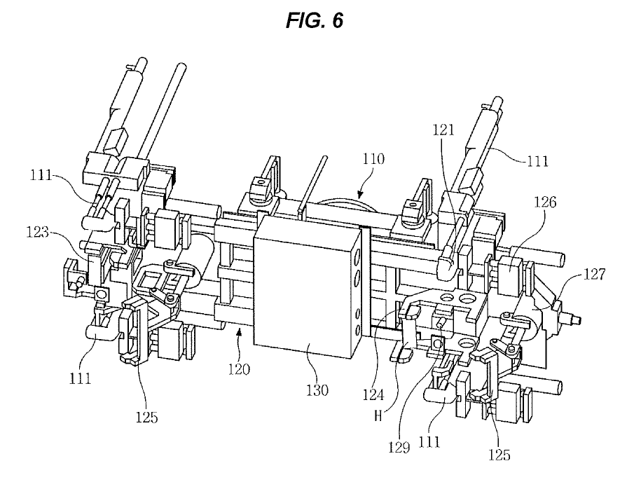

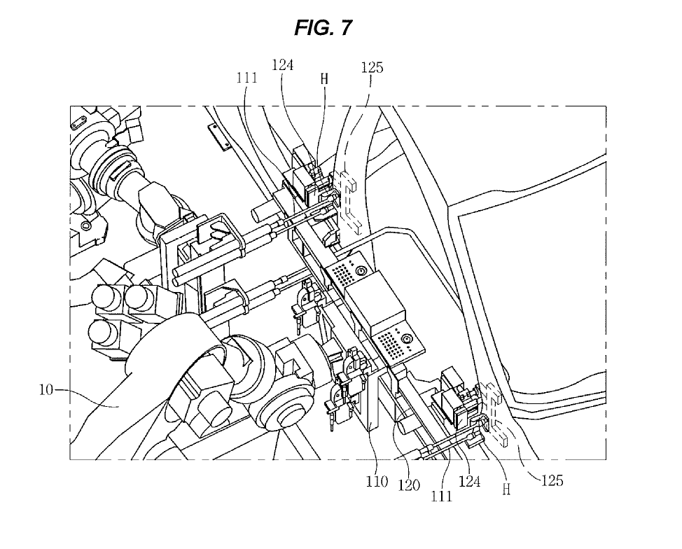

A door hinge H (see FIGS. 6 and 7) is a part that is mounted on a side panel and to open/close a door and well known in the art, so the detailed description is not provided.

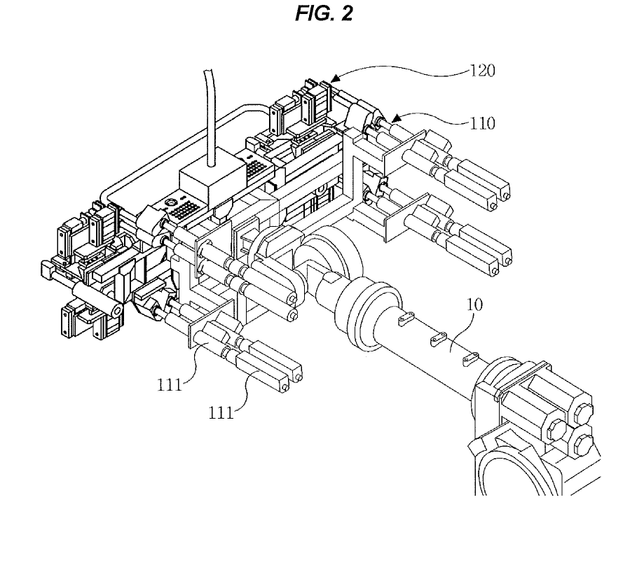

As shown in FIGS. 1 and 2, the present invention includes the robot hanger unit 110 that is mounted on the automatic robot 10 and the door hinge mounting unit 120 that is mounted on the robot hanger unit 110.

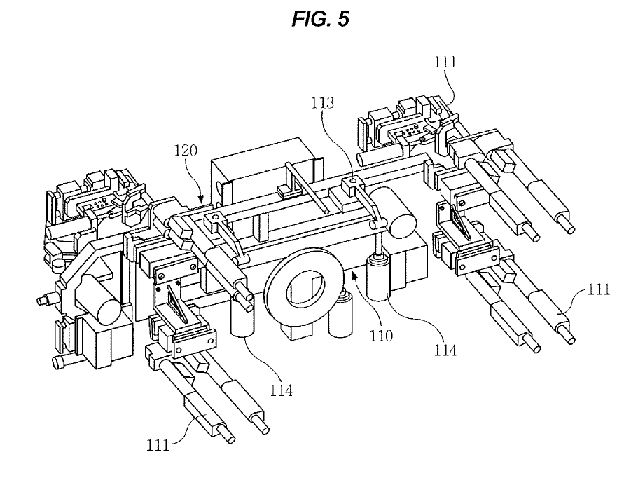

First, as shown in FIGS. 5 to 7, the automatic robot 10 moves the door hinge mounting unit 120 picking up a door hinge H so that the door hinge mounting unit 120 may mount the door hinge H to a side panel of a vehicle, and in detail, the robot hanger unit 110 is coupled to the end of the automatic robot 10 and the door hinge mounting unit 120 is mounted on the robot hanger unit 110 and operated by the automatic robot 10 so that the door hinge H may be mounted on the side panel.

That is, the automatic robot 10 is combined with the door hinge mounting unit 120 through the robot hanger unit 110, is rotated and moved by a control unit 130, picks up the door hinge H, using the door hinge mounting unit 120, and then rotates to a side panel of a vehicle and mounts the door hinge H to the side panel.

The door hinge mounting unit 120, as shown in FIGS. 5 and 6, may include a door hinge fixing member 126 that restricts movement of the door hinge H that is being mounted on a side panel of a vehicle, a first clamp 127 that fixes the positions of a side panel of a vehicle and the door hinge mounting unit 120, and a tooling pin 129 that provides a reference for mounting the door hinge H.

The door hinge mounting unit 120 prevents the door hinge H from separating, when it is mounted on the robot hanger unit 110 and moves with the door hinge H picked up to the side panel, and it may guide the door hinge H that is being mounted on the side panel so that the door hinge may be mounted exactly where a door is mounted on the side panel.

To this end, as shown in FIGS. 6 and 7, a holder 124 that picks up the door hinge H may be disposed on the front of the door hinge mounting unit 120 to prevent the door hinge H from separating from the door hinge mounting unit 120.

A fixing member 125 that fixes a side panel of a vehicle and the door hinge mounting unit 120 when the door hinge H is mounted may also be disposed on the front of the door hinge mounting unit 120 so that accuracy in mounting of the door hinge H to the side panel may be improved.

The fixing member 125 may rotate and selectively fix a side panel and the door hinge mounting unit 120 by preventing the door hinge mounting unit 120 from interfering with the side panel before the door hinge H is mounted on the side panel and by fixing the side panel and the door hinge mounting unit 120 while the door hinge is mounted.

A sensor 123 that senses a tooling hole in a side panel of a vehicle where a door hinge is mounted may be disposed on the front of the door hinge mounting unit 120 in order to improve accuracy in mounting of a door hinge on the side panel and adjust the gap between the vehicle body and the door hinge mounting unit 120.

As shown in FIGS. 5 to 7, nut runners 111 that fasten the door hinge H to a side panel are disposed on the robot hanger unit 110, such that the door hinge H is fastened to the side panel by securing bolts on the door hinge H, when the door hinge H is positioned on the side panel.

A plurality of sockets 121 for fastening bolts is formed through the door hinge mounting unit 120 and the nut runners 111 of the robot hanger unit 110 are inserted in the sockets 121 of the door hinge mounting unit 120 and fastened by bolts therein, such that the door hinge H may be mounted on the side panel.

The robot hanger unit 110 may include a location pin 113 connecting the robot hanger unit 110 with the door hinge mounting unit 120 and a second clamp 114 fixing the door hinge mounting unit 120.

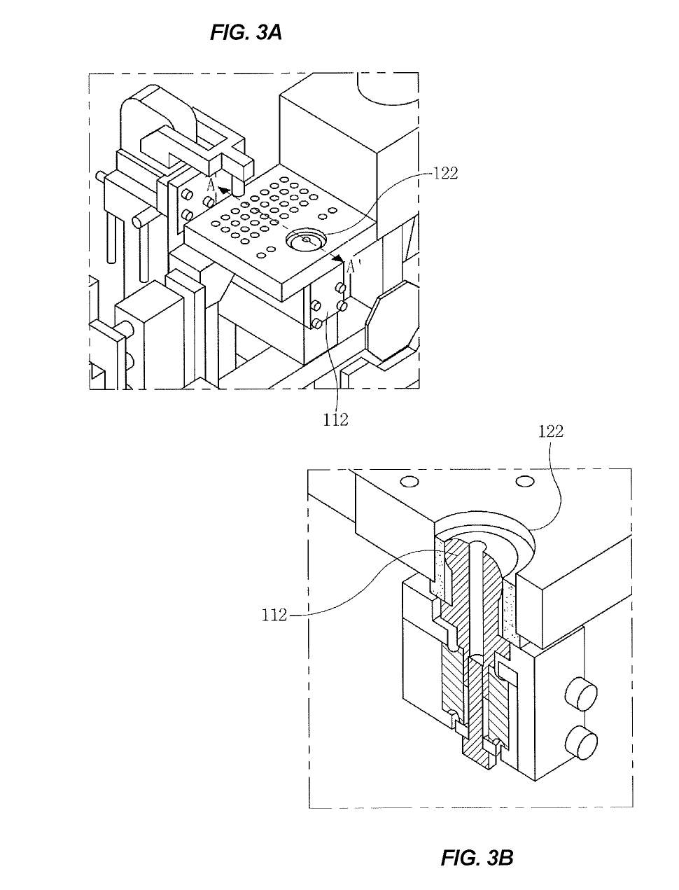

As shown in FIGS. 1 and 3, a plurality of insertion holes 122 is formed in the door hinge mounting unit 120 and a plurality of floating pins 112 is formed on the robot hanger unit 110 and may be inserted into the insertion holes 122, such that the door hinge mounting unit 120 and the robot hanger unit 110 may be combined. Depending on circumstances, the floating pins 112 may be pulled out of the insertion hole 122 so that the door hinge mounting unit 120 may be replaced in accordance with the types of vehicles by separating the door hinge mounting unit 120 from the robot hanger unit 110.

Further, a plurality of door hinge mounting units 120 may be provided such that different door hinge mounting units 120 may be mounted on the robot hanger unit 110 and only they may be replaced with the nut runners 111 of the robot hangers 110 keep used in common, depending on the types of vehicles, so the cost for replacing the nut runners 111 is reduced.

That is, according to an exemplary embodiment of the present invention, the door hinge mounting unit 120 picks up the door hinge H through the robot hanger unit 110 coupled to the automatic robot 10, the robot hanger unit 110 is mounted on the automatic robot 10, the door hinge mounting unit 120 is detachably coupled to the robot hanger unit 110 and easily replaced, depending on the types of vehicles, the robot hanger unit 110 has the nut runners 111 for fastening the door hinge H to a side panel of a vehicle, and the nut runner 111 may keep used, even if the door hinge mounting unit 120 is replaced. Therefore, it is possible to minimize the cost and improve the operation rate by reducing the cost for replacing the nut runners 111.

As set forth above, according to exemplary embodiments of the present invention, it is possible to minimize the cost and improve the operation rate by reducing use of the nut runners, by way of using the nut runners in common when automatically mounting door hinges for front and rear doors to a side panel of a vehicle.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An automatic mounting device of a door hinge for a vehicle, comprising:
a door hinge mounting unit configured to automatically mount a door hinge to a side panel of the vehicle; and
a robot hanger unit mounted on the door hinge mounting unit, coupled to an automatic robot, and configured to allow the door hinge mounting unit to move.

2. The automatic mounting device of the door hinge for the vehicle according to claim 1, wherein the door hinge mounting unit includes:
the door hinge fixing member configured to restrict a movement of the door hinge when the door hinge is mounted on the side panel of the vehicle;
a first clamp configured to fix positions of the side panel of the vehicle and the door hinge mounting unit; and
a tooling pin configured to provide a reference for mounting the door hinge.

3. The automatic mounting device of the door hinge for the vehicle according to claim 2, wherein the door hinge mounting unit has a plurality of sockets formed therein for fastening bolts, and the robot hanger unit has nut runners being inserted into the sockets and mounting the door hinge to the side panel of the vehicle by fastening the bolts.

4. The automatic mounting device of the door hinge for the vehicle according to claim 3, wherein the robot hanger unit includes:
a location pin configured to connect the robot hanger unit with the door hinge mounting unit; and
a second clamp configured to fix the door hinge mounting unit.

5. The automatic mounting device of the door hinge for the vehicle according to claim 1, wherein a holder configured to pick up the door hinge is disposed at a front of the door hinge mounting unit.

6. The automatic mounting device of the door hinge for the vehicle according to claim 1, wherein a fixing member configured to fix the side panel of the vehicle and the door hinge mounting unit when the door hinge is mounted is disposed at a front of the door hinge mounting unit.

7. The automatic mounting device of the door hinge for the vehicle according to claim 6, wherein the fixing member is rotatable and selectively fixes between the side panel and the door hinge mounting unit.

8. The automatic mounting device of the door hinge for the vehicle according to claim 1, wherein the door hinge mounting unit is detachable from the robot hanger unit.

9. The automatic mounting device of the door hinge for the vehicle according to claim 1, wherein a plurality of insertion holes is formed in the door hinge mounting unit, and a plurality of floating pins is formed on the robot hanger unit and inserted in the insertion holes.

10. The automatic mounting device of the door hinge for the vehicle according to claim 1, wherein a sensor configured to sense a tooling hole in the side panel of the vehicle where the door hinge is mounted is disposed at a front of the door hinge mounting unit.

11. The automatic mounting device of the door hinge for the vehicle according to claim 1, wherein a plurality of door hinge mounting unit is provided and mounted on the robot hanger unit, depending on types of vehicles.

12. The automatic mounting device of the door hinge for the vehicle according to claim 1, wherein the automatic robot is coupled to the door hinge mounting unit through the robot hanger unit and a control unit is disposed in the door hinge mounting unit so that the door hinge is mounted on the side panel of the vehicle by the door hinge mounting unit.
